(19) United States
(12) Patent Application Publication
(10) Pub. No.: US 2004/0037241 A1
(43) Pub. Date: Feb. 26, 2004

(54) Interlaced frequency division duplexing method for duplex communication system

(75) Inventors: Ki Seon Kim, Buk-gu (KR); Hong Ku Kang, Buk-gu (KR)

Correspondence Address: PATENT LAW GROUP LLP, 2635 NORTH FIRST STREET, SUITE 223, SAN JOSE, CA, 95134, US

(73) Assignee: KWANGJU INSTITUE OF SCIENCE AND TECHNOLOGY

(21) Appl. No.: 10/346,432

(22) Filed: Jan. 16, 2003

(30) Foreign Application Priority Data
Aug. 22, 2002 (KR) 2002-49844

(51) Int. Cl. H04Q 7/00

(52) U.S. Cl. 370/329

(57) ABSTRACT

Disclosed herein is an interlaced frequency division duplexing method for a duplex communication system. The present invention is constructed to estimate feedback information of a transmission frequency channel using a reception frequency channel. In the interlaced frequency division duplexing method, a frequency band of the duplex communication system is divided into a plurality of frequency channels so as to guarantee similarity between channel characteristics of neighboring frequency channels. Transmission and reception channels are alternately allocated to the plural frequency channels. Accordingly, the present invention can allow a transmitting end of the duplex communication system to easily estimate the variation of feedback information due to the variation of channel characteristics without reducing transmission efficiency under a time-varying multi-path channel environment, and which can prevent the performance of the duplex communication system from being deteriorated due to the variation of channel characteristics.

### BACKGROUND OF THE INVENTION

1. Field of the Invention

The present invention relates generally to a frequency division duplexing method for a duplex communication system, and more particularly to an interlaced frequency division duplexing method, which allows a transmitting end of a duplex communication system to promptly estimate the variation of feedback information under a time-varying multi-path channel environment without decreasing frequency efficiency and transmission power efficiency, and which prevents the performance of a high speed wideband transmission system from deteriorating due to the variation of channel characteristics under a rapidly time-varying multi-path channel environment.

2. Description of the Prior Art

Generally, a communication system is required to support duplex communication, in which transmission and reception communication can be performed, rather than simplex communication. Further, in order to support a high speed wideband transmission under a time-varying multi-channel environment, a limited frequency band must be efficiently used, and the efficiency of transmission power must be increased. In order to improve such transmission efficiency, there has been widely researched a system that increases transmission efficiency by informing the transmitting end of a reception signal to noise (S/N) ratio, channel information or the like of a receiving end as feedback information, executing appropriate processing using the feedback information, and transmitting corresponding data. There are two duplexing methods generally used in a duplex communication system using such feedback information: one is a frequency division duplexing method and the other is a time division duplexing method.

As shown in FIG. 1, the frequency division duplexing method works such that an entire frequency band of a duplex communication system is divided into two consecutive frequency channels, wherein one frequency channel is used for transmission and the other frequency channel is used for reception. In such a frequency division duplexing method, since a coherent frequency band of a channel is generally much smaller than a frequency band of a wideband system in case of the wideband system, the wideband system cannot estimate feedback information through a reception channel due to a difference between channel characteristics of transmission and reception channels. Therefore, it is necessary to provide to prepare an additional feedback channel and transmit feedback information through the feedback channel. Such an additional feedback channel always exists on a time axis, so the wideband system can always inform a transmitting end of the variation of feedback information even though the feedback information varies due to the variation of channel characteristics under a time-varying multi-path environment. However, the frequency division duplexing method is problematic in that, since it uses the additional feedback channel, frequency efficiency is decreased and transmission power is wasted, thus decreasing transmission efficiency.

As shown in FIG. 2, the time division duplexing method works such that transmission and reception are performed using time slots on a time axis instead of using an entire frequency band of a duplex communication system for both transmission and reception. Therefore, a transmitting end of the duplex communication system can estimate required feedback information using reception slots by using an appropriate method when data are received. Accordingly, in the time division duplexing method, since the transmitting end can estimate feedback information without using an additional feedback channel, the decrease of transmission efficiency which may occur in the frequency division duplexing method does not occur. However, the time division duplexing method is problematic in that, since reception slots are discontinuous on the time axis, the duplex communication system cannot inform the transmitting end of the variation of feedback information due to the variation of channel characteristics under a time-varying multi-path channel environment, thus deteriorating the performance of a duplex communication system.

### SUMMARY OF THE INVENTION

Accordingly, the present invention has been made keeping in mind the above problems occurring in the prior art, and an object of the present invention is to provide an interlaced frequency division duplexing method for a duplex communication system, which allows a transmitting end to promptly estimate the variation of feedback information under a time-varying multi-path channel environment without decreasing frequency efficiency and transmission power efficiency in the duplex communication system, thus preventing the performance of a high speed wideband transmission system from deteriorating due to the variation of channel characteristics under a rapidly time-varying multi-path channel environment.

In order to accomplish the above object, the present invention provides an interlaced frequency division duplexing method for a duplex communication system comprising the steps of dividing a frequency band of the duplex communication system into a plurality of frequency channels so as to guarantee similarity between channel characteristics of neighboring frequency channels; and alternately allocating transmission and reception channels to the plural frequency channels.

Further, the interlaced frequency division duplexing method of the present invention can guarantee the similarity between channel characteristics of neighboring channels by dividing a frequency band of a duplex communication system into a plurality of frequency channels, and can easily estimate feedback information on the basis of the variation of channel characteristics using the fact that characteristics of a reception channel adjacent to a transmission channel are similar to those of the transmission channel without using an additional feedback channel by allocating the frequency channels to transmission and reception to be interlaced. Further, since the present invention does not use an additional feedback channel, it can maintain high frequency efficiency and high transmission power efficiency, which are advantages of a time division duplexing method, and it can easily estimate feedback information even under a time-varying multi-path channel environment.

The interlaced frequency division duplexing method of the present invention having the above construction can also be applied to a typical duplex communication system using feedback information as well as an Orthogonal Frequency Division Multiplexing (OFDM) system, and can be applied to duplex communication systems regardless of kinds of feedback information.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing a Frequency Division Duplexing (FDD) method in a duplex communication system with two consecutive transmission/reception frequency channels;

FIG. 2 is a graph showing a Time Division Duplexing (TDD) method in a duplex communication system with four time slots and one frequency channel;

FIG. 3 is a graph showing a frequency channel division method guaranteeing similarity between characteristics of neighboring frequency channels;

FIG. 4 is a graph showing an Interlaced Frequency Division Duplexing (IFDD) method of the present invention applied to a duplex communication system with N frequency channels; and

FIG. 5 is a graph showing bit error rates of an OFDM Subchannel Space-Combining Transmission Diversity (SSCTD) system to which the present invention is applied and an OFDM SSCTD system to which a typical time division duplexing method is applied, according to the moving speed of a receiver.

### DESCRIPTION OF THE PREFERRED EMBODIMENTS

Hereinafter, embodiments of an interlaced frequency division duplexing method of the present invention will be described in detail with reference to the attached drawings.

The present invention discloses a duplexing method guaranteeing robustness of a time-varying multi-path channel in a duplex communication system which utilizes technologies improving transmission efficiency using feedback information at a transmitting end.

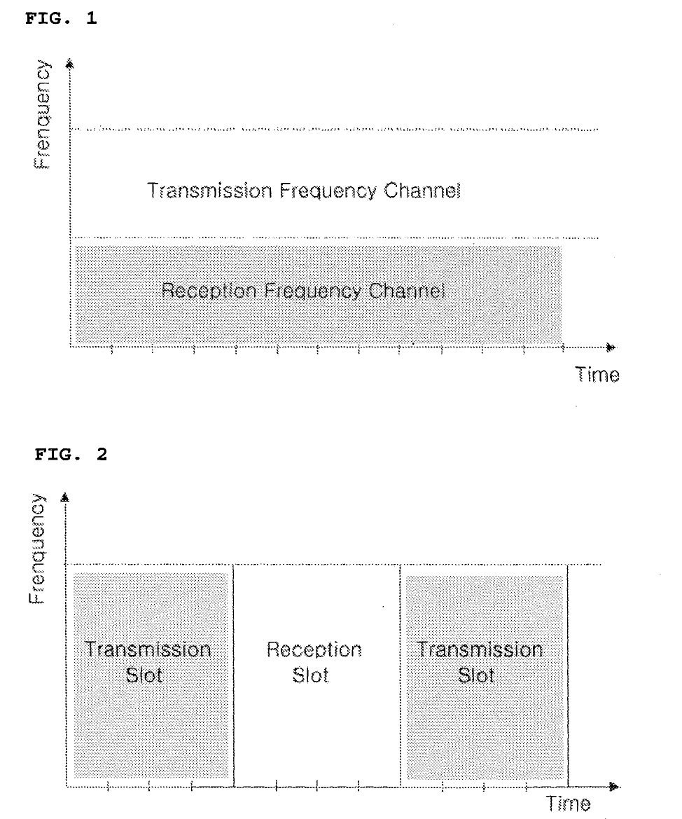

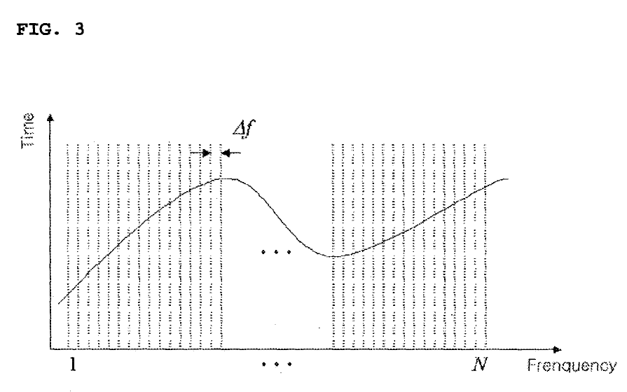

There are two methods of informing a transmitting end of feedback information: a first method uses an additional feedback channel, as shown in the frequency division duplexing method of FIG. 1, and a second method estimates feedback information using reception slots, as shown in the time division duplexing method of FIG. 2. However, the first method using an additional feedback channel in the frequency division duplexing method decreases transmission efficiency, and the second method estimating feedback information using reception slots in the time division duplexing method decreases the performance of a duplex communication system under a time-varying multi-path channel environment.

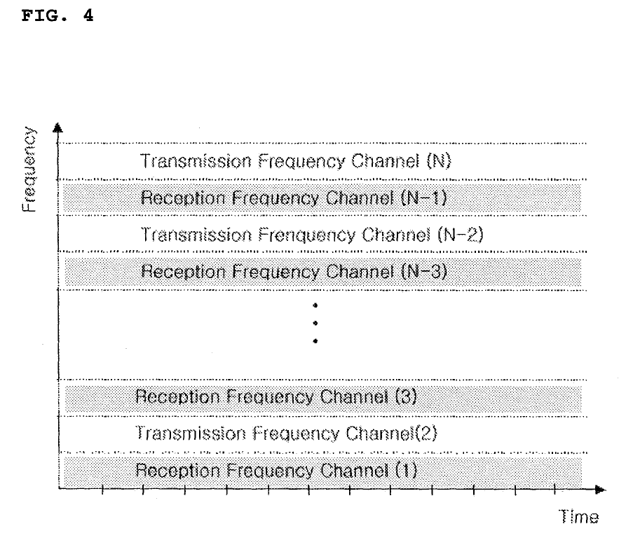

As shown in FIG. 3, the interlaced frequency division duplexing method of the present invention comprises a process of dividing an entire frequency band of a duplex communication system into a plurality of small frequency bands, that is, N frequency channels each with a frequency band of Δf. Generally, the entire frequency band is characterized by frequency selective fading in a frequency domain. In this case, the interlaced frequency division duplexing method enables each of frequency channels to represent frequency-flat fading characteristics by dividing the entire frequency band into a plurality of frequency channels. Further, the present invention can guarantee the similarity between characteristics of neighboring frequency channels by increasing the number of frequency channels N. That is, as shown in FIG. 4, the interlaced frequency division duplexing method assigns even frequency channels to transmission and odd frequency channels to reception by considering that neighboring frequency channels of N frequency channels have similar characteristics in FIG. 3. Alternatively, the interlaced frequency division duplexing method can assign even frequency channels to reception and odd frequency channels to transmission. Accordingly, the interlaced frequency division duplexing method can easily estimate feedback information of transmission frequency channels using reception frequency channels. The estimation of feedback information of the transmission frequency channels using the reception frequency channels can be expressed by the following Equations [1-1] and [1-2],

I₂ₖ₊₁=ƒ(I₂, I₄, . . . , I₂ₖ, . . . , I_{N}) [1-1]

I₂ₖ=ƒ(I₁, I₃, . . . , I₂ₖ₊₁, . . . , I_{N}) [1-2]

where Iₖ is feedback information of a k-th frequency channel, and f( ) is an estimation function obtaining transmission frequency channel information using reception frequency channel information.

Hereinafter, a system employing an Orthogonal Frequency Division Multiplexing (OFDM) transmission method using a plurality of frequency channels is descried as a preferred embodiment to which the frequency division duplexing method of the present invention is applied. Further, the performance of a Subchannel Space-Combining Transmission Diversity (SSCTD) is considered as a technology using feedback information so as to improve transmission efficiency. The SSCTD is one of transmission diversity technologies which selects an antenna with a largest gain among M transmission antennas, uses gains of respective subchannels as feedback information, and transmits feedback information through the selected antenna so as to improve the performance of the OFDM system.

In order to check the performance of the present invention, an OFDM system using SSCTD based on the time division duplexing method (hereinafter referred to as an “OFDM SSCTD/TDD system”) and an OFDM system using SSCTD based on the interlaced frequency division duplexing method of the present invention (hereinafter referred to as an “OFDM SSCTD/IFDD system”) are considered. In the OFDM SSCTD/TDD system, a time difference between the estimation and transmission of feedback information is given as a difference between the last time of a time slot and the transmission time. On the other hand, in the OFDM SSCTD/IFDD system, the time difference between the estimation and transmission of feedback information is always fixed to an interval of a single symbol. This result means that the variation of feedback information can be promptly estimated under a time-varying multi-path channel environment. Further, the OFDM SSCTD/IFDD system can use the various estimation functions f( ) given in Equations [1-1] and [1-2] so as to estimate feedback information of transmission channels. However, the OFDM SSCTD/IFDD system may preferably use a simple linear interpolation expressed by the following Equation [2] so as to reduce complexity when the system is implemented,

$${h}_{2 k + 1} = \frac{{h}_{2 k} + {h}_{2 k + 2}}{2} \qquad [ 2 ]$$

where hₖ is feedback information, which represents a gain of the frequency channel.

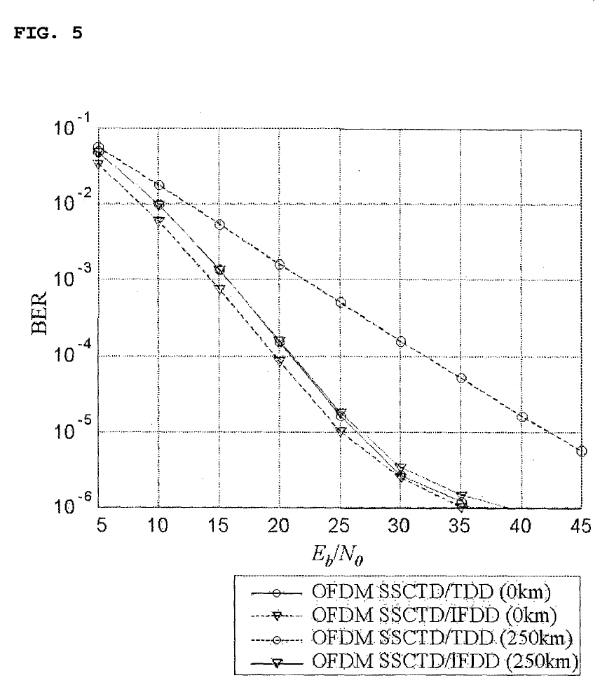

FIG. 5 is a graph showing simulated results of bit error rates (BER) of the OFDM SSCTD/IFDD system using the interlaced frequency division duplexing method of the present invention, and the OFDM SSCTD/TDD system using the conventional time division duplexing method. In the simulation, an OFDM system using 128 subcarriers was used. Further, a COST 259 channel model having Doppler frequencies corresponding to terminals with moving speeds of 0 km/h and 250 km/h, respectively, was introduced so as to represent a time-invariant multi-path channel and a time-varying multi-path channel, respectively. Further, in order to check influences caused by the applications of other duplexing methods, it was assumed that time and frequency are fully synchronized, feedback information hₖ is perfectly estimated, and the lengths of both transmission and reception slots are 50 OFDM symbols.

Referring to FIG. 5, under the time-constant multi-path channel environment, the OFDM SSCTD/TDD system and the OFDM SSCTD/IFDD system represent performances of similar bit error rates. Meanwhile, if a used channel is a rapidly time-varying multi-path channel, the bit error rate of the OFDM SSCTD/TDD system represents greatly decreased performance, while the bit error rate of the OFDM SSCTF/IFDD system represents almost the same performance as that of the bit error rate under the time-constant multi-path channel environment. In this way, if a duplex communication system using feedback information employs the Interlaced Frequency Division Duplexing (IFDD) method of the present invention, a transmitting end of the duplex communication system can promptly estimate the variation of feedback information due to the time-varying multi-path channel without wasting additional transmission efficiency, thus supporting a robust duplex communication system under the time-varying multi-path channel environment.

As described above, the present invention provides an interlaced frequency division duplexing method for a duplex communication system, which can allow a transmitting end of the duplex communication system to easily estimate the variation of feedback information due to the variation of channel characteristics without reducing transmission efficiency under a time-varying multi-path channel environment, and which can prevent the performance of the duplex communication system from being deteriorated due to the variation of channel characteristics.

Further, the present invention is advantageous in that the interlaced frequency division duplexing method of the present invention can also be applied to typical duplex communication systems using feedback information as well as an OFDM system, and can be used regardless of kinds of feedback information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An interlaced frequency division duplexing method for a duplex communication system to estimate feedback information of a transmission frequency channel using a reception frequency channel, comprising the steps of:
dividing a frequency band of the duplex communication system into a plurality of frequency channels so as to guarantee similarity between channel characteristics of neighboring frequency channels; and
alternately allocating transmission and reception channels to the plural frequency channels.

2. The interlaced frequency division duplexing method according to claim 1, wherein the estimation of the feedback information is expressed by a function in the following Equation (f):
I₂ₖ₊₁=ƒ(I₂, I₄, . . . , I₂ₖ, . . . , I_{N})
where Iₖ of the right term represents feedback information of a k-th frequency channel and N of the left term represents the number of divided frequency channel.

3. The interlaced frequency division duplexing method according to claim 1, wherein the estimation of the feedback information is expressed by a function in the following Equation (f):
I₂ₖ=ƒ(I₁, I₃, . . . , I^{2k+1}, . . . , I_{N})
where Iₖ of the right term represents feedback information of a k-th frequency channel and N of the left term represents the number of divided frequency channel.

4. The interlaced frequency division duplexing method according to claim 1, wherein the estimation of the feedback information is performed using a linear interpolation expressed by the following Equation:
$${h}_{2 k + 1} = \frac{{h}_{2 k} + {h}_{2 k + 2}}{2}$$
where hₖ is feedback information of a k-th frequency channel, and represents a gain of the frequency channel.

5. The interlaced frequency division duplexing method according to claim 1, wherein the duplex communication system includes an orthogonal frequency division multiplexing system.
